(19) United States
(12) Patent Application Publication
(10) Pub. No.: US 2014/0082258 A1
(43) Pub. Date: Mar. 20, 2014

(54) MULTI-SERVER AGGREGATED FLASH STORAGE APPLIANCE

(71) Applicant: LSI CORPORATION, Milpitas, CA (US)

(72) Inventor: Robert Ober, Santa Clara, CA (US)

(73) Assignee: LSI CORPORATION, Milpitas, CA (US)

(21) Appl. No.: 13/622,684

(22) Filed: Sep. 19, 2012

(51) Int. Cl. G06F 12/02; G06F 15/173

(52) U.S. Cl. 711/103; 709/238; 711/170; 711/E12.008

(57) ABSTRACT

A device for aggregating flash modules includes a switch to connect to a plurality of servers and a midplane to connect to a plurality of flash modules. The switch and midplane are connected such that the switch can route data traffic to any of the plurality of flash modules, and the plurality of servers can connect to the plurality of flash modules transparently, as if a flash module was directly installed into a server.

### FIELD OF THE INVENTION

The present invention is directed generally toward computer storage, and more particularly toward solid-state computer storage in a multi-server environment.

### BACKGROUND OF THE INVENTION

NAND flash used in storage is finding substantial use in enterprise and servers as high performance cache of large storage pools of data that reside on disk and as primary storage for performance applications.

The current physical market for NAND flash devices in servers has become bi-modal. On one hand, NAND flash devices are used as disk replacements (often for caching) in existing style infrastructure. This has benefits in field replacement, but performance is limited because it is either tied to one server only, or is in a storage area network storage array at the far end of a small bandwidth, high latency interconnect like Fiber Channel. On the other hand, PCIe flash cards are being installed directly in servers. This gives high bandwidth, low latency performance, but if the server fails, the data is stranded. If the card fails it is very difficult to service. The flash cannot be re-allocated to other servers either. It is physically tied to the server it is plugged into.

Consequently, it would be advantageous if an apparatus existed that is suitable for making multiple NAND flash devices accessible to multiple servers but with the performance of direct PCIe attached NAND flash storage.

### SUMMARY OF THE INVENTION

Accordingly, the present invention is directed to a novel method and apparatus for making multiple NAND flash devices accessible to multiple servers.

One embodiment of the present invention is a system comprising two or more servers connected to a switch, and the switch. The Switch may be connected to a midplane or cabling. The midplane or cabling is connected to a plurality of NAND flash devices such that each server may access any of the NAND flash devices through the switch and midplane or cabling.

Another embodiment of the present invention is a system comprising two or more servers connected to a switch or expander, the switch connected to a midplane, and the midplane connected to a plurality of NAND flash devices. In the event of a server failure, the switch and midplane are configured to route traffic from one or more NAND flash devices away from the failed server. In the event of an NAND flash device failure, the switch and midplane are configured to route traffic from a server away from the failed NAND flash device.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of a system having a switch and a midplane for connecting two or more servers to a plurality of NAND flash devices;

FIG. 2 shows a block diagram of a system having a switch and a midplane where the switch may be configured to reroute data traffic in the event of a failure, migration of resources or application hibernation; and

FIG. 3 shows a flowchart of a method for re-routing traffic in the event of a server failure or an active reconfiguration of resources.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

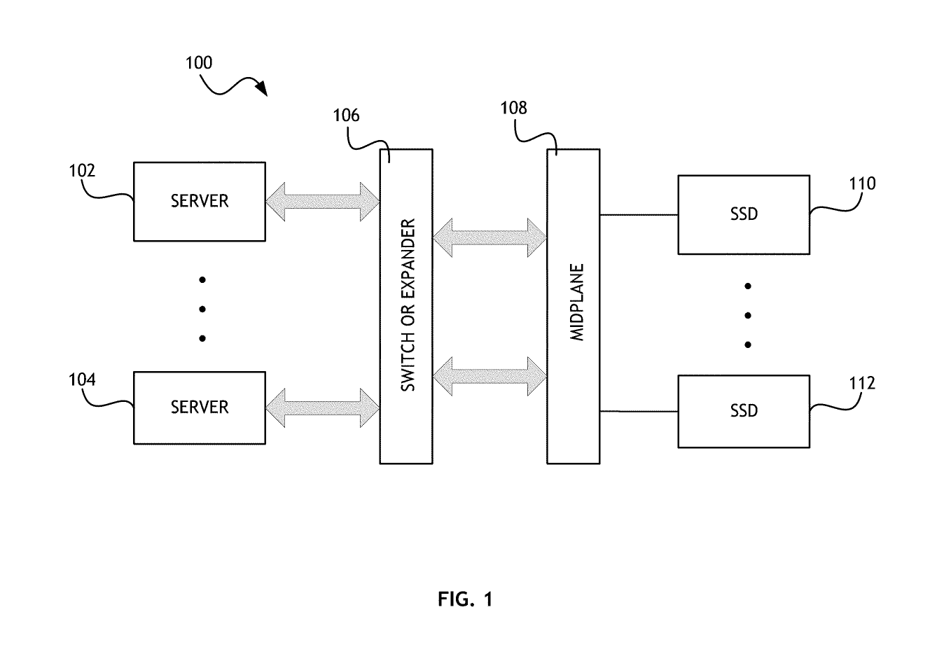

referring to FIG. 1, a block diagram of a system 100 having a switching device 106 and a midplane 108 for connecting two or more servers 102, 104 to a plurality of NAND flash devices 110, 112 is shown. In the context of the present invention, ‘switching device’ should be understood to include any device suitable for routing data traffic in a network, including network switches and expanders, and particularly SAS switches and SAS expanders. NAND flash devices 110, 112 are routinely connected directly to servers 102, 104 such that a single server 102, 104 may communicate with a NAND flash device 110, 112 to the exclusion of any other server 102, 104. Such connections provide high bandwidth and low latency between the server 102, 104 and the NAND flash device 110, 112. However, where a NAND flash device 110, 112 is directly connected to a server 102, 104, any information contained in the NAND flash device 110, 112 may become inaccessible in the event the server 102, 104 fails. Likewise, in the event the NAND flash device 110, 112 fails, the server may not have access to another NAND flash device 110, 112 to perform similar functions; and the failed NAND flash device 110, 112 may be difficult to access and service.

According to one embodiment of the present invention, each server 102, 104 in the system 100 may be connected to a switching device 106. The switching device 106 may include a low-latency crossbar infrastructure such that data traffic between any port and any other port is extremely low-latency. The switching device 106 may route data traffic between the servers 102, 104 and a midplane 108. The midplane 108 may be connected to a plurality of NAND flash devices 110, 112. Each server 102, 104 may be configured to connect to one or more of the NAND flash devices 110, 112 through the switching device 106 and midplane 108 as if the one or more NAND flash devices 110, 112 were connected to the server 102, 104 directly. One skilled in the art may appreciate that the midplane 108 may comprise cabling connecting the switching device 106 to each of the NAND flash device 110, 112. The switching device 106 may be configured to route data traffic from a server 102, 104 to a NAND flash device 110, 112 and from an NAND flash device 110, 112 to a server 102, 104 as if the server 102, 104 and NAND flash device 110, 112 were directly connected. One or more of the servers 102, 104 may comprise virtual machines or multiple virtual machines per physical machine.

In some applications, it may be desirable to “hibernate” a virtual machine. For example, some “overnight” applications run at close of business each day for six to eight hours but stop running when normal business resumes. Such overnight applications may produce a “hot” dataset that requires additional processing, but such processing may only continue during the next overnight period. Rebuilding the hot dataset may require hours of processing time. It would be more efficient to “park” the hot dataset and the virtual machine image during normal business hours. Where there are more NAND flash devices 110, 112 connected to the midplane 108 than currently allocated to servers 102, 104, such NAND flash devices 110, 112 may be allocated to hibernate a virtual machine image and/or park a hot dataset.

Furthermore, virtual machines are often used package a machine image so that the image is independent of the physical machine the image is running on. In some embodiments a NAND flash device 110, 112 may store a virtual machine for migration from one device (such as a server 102, 104) to another device. In this embodiment, the virtual machine functioning as a device independent container may be stored on a NAND flash device 110, 112 by the server 102, 104 currently executing the virtual machine, and the NAND flash device 110, 112 may be transferred via the switching device 106 to a different server 102, 104.

Each server 102, 104 may include a PCIe to interconnect adaptor to allow each server 102, 104 to connect to the switching device 106 through a PCIe port. The switching device 106 may be an SAS switch. The switching device 106 may also include a plurality of SAS/SATA ports attached to the midplane 108 with each port mapped to a SAS/SATA connector on the midplane 108. The midplane 108 may be configured to hold a plurality of PCIe flash cards, and connect each PCIe flash card to the switching device 106 through a single SAS/SATA port.

In this embodiment, each server 102, 104 may function as though the NAND flash device 110, 112 where directly connected to the server, with substantially the same latency and bandwidth. However, the switching device 106 may re-allocate NAND flash devices 110, 112 from one server 102, 104 to another in the event a server 102, 104 fails or in the event the configuration of a virtual machine changes. A person skilled in the art may appreciate that the embodiment described herein may be scalable depending on the capacity of the switching device 106. Furthermore, even though the NAND flash devices 110, 112 may function as though they are directly connected to a server 102, 104, serviceability may be enhanced because the NAND flash devices 110, 112 are removed from the hostile environment of the server 102, 104. Furthermore, various operational parameters may be optimized; for example, the temperature may be maintained to improve electron mobility. The potential for catastrophic system 100 failure is also minimized because component failures may be segregated by the switching device 106.

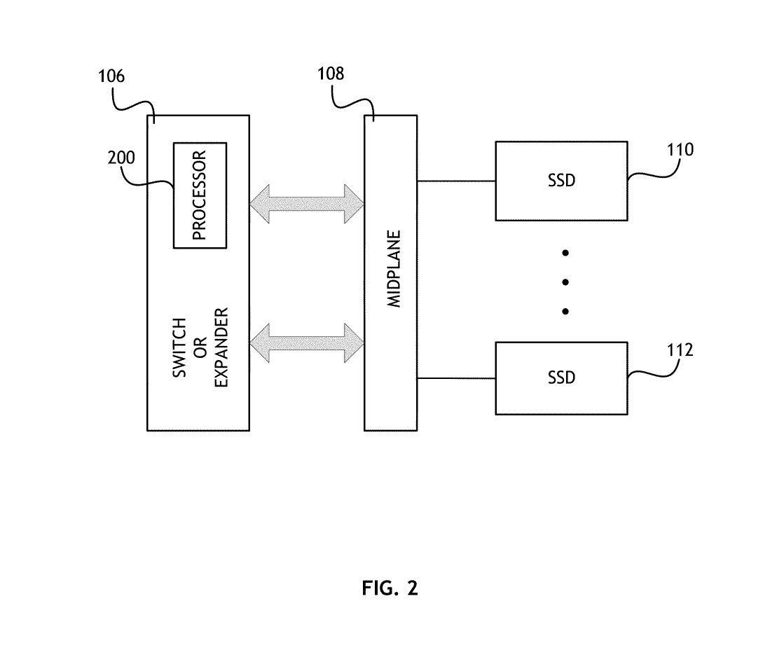

Referring to FIG. 2, a block diagram of a system having a switching device 106 and a midplane 108 where the switching device 106 may be configured to reroute data traffic in the event of a failure, migration of resources or application hibernation is shown. The switching device 106 may include a processor 200. The processor 200 may be configured to identify a failed server and de-allocate and NAND flash devices 110, 112 associated with that failed server. The processor 200 may then re-allocate the NAND flash devices 110, 112 to a different, functional server also connected to the switching device 106 so that data on the NAND flash devices 110, 112 may continue to be available. Alternatively, a remote system (not shown) may de-allocate and re-allocate NAND flash devices 110, 112, facilitated by the processor 200.

Alternatively, in the event a first NAND flash device 110 fails, the processor 200 may be configured to identify and de-allocate the failed first NAND flash device 110 from an associated server and allocate a second functional NAND flash device 112 to that server.

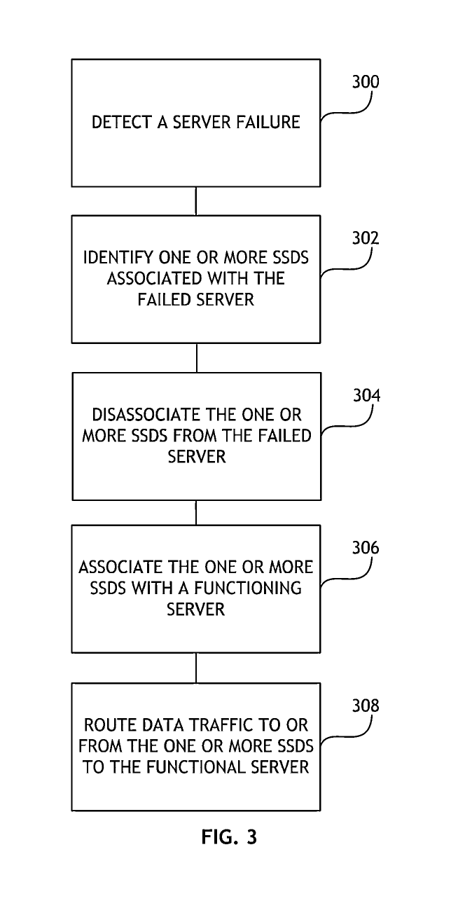

Referring to FIG. 3, a flowchart of a method for re-routing traffic in the event of a server failure is shown. An apparatus including a switch and a midplane may detect 300 the failure of a server connected to the switch. The Apparatus may be an automated monitoring agent executing on a processor in a server center. The failed server may be connected to the switch through a PCIe port and a PCIe to SAS adapter. The apparatus may identify 302 one or more NAND flash devices connected to the midplane, associated with the failed server. The NAND flash devices may be PCIe flash modules. The apparatus may disassociate 304 the one or more NAND flash devices from the failed server and associates 306 the one or more NAND flash devices with a functional server by updating pertinent routing information related to the one or more NAND flash devices and servers. The apparatus may then route 308 data traffic to or from the one or more NAND flash devices and the functional server.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An apparatus for routing data traffic between one or more servers and one or more solid state storage devices, comprising:
one of a switch or expander comprising a processor;
a midplane connected to the one of a switch or expander; and
computer executable program code configured to execute on the processor, wherein:
the midplane is configured to connect to one or more solid state storage devices;
the one of a switch or expander is configured to connect to one or more servers; and
the computer executable program code is configured to:
maintain a data structure configured to associate one or more solid state storage devices with a server; and
route data traffic between the server and the associated one or more solid state storage devices.

2. The apparatus of claim 1, wherein the one of a switch or expander is an SAS switch.

3. The apparatus claim 1, wherein the midplane comprises a plurality of miniature SAS / SATA ports.

4. The apparatus of claim 3, wherein the one of a switch or expander is connected to the midplane through a plurality of connections, each connection comprising a connection between a single port of the one of a switch or expander and a single miniature SAS/SATA port of the midplane.

5. The apparatus of claim 1, wherein the computer executable program code is configured to:
identify a failed server;
de-allocate one or more solid state storage devices associated with the failed server; and
re-allocate the one or more solid state storage devices to a functional server.

6. The apparatus of claim 1, wherein the computer executable program code is configured to:
identify a failed solid state storage device; and
de-allocate the failed solid state storage devices from an associated server.

7. The apparatus of claim 6, wherein the computer executable program code is further configured to allocate a functional solid state storage device to the associated server.

8. The apparatus of claim 1, wherein at least one of the one or more servers comprises a virtual machine.

9. A method for managing solid state storage device allocation comprising:
connecting to a PCIe port in a server with a switching device;
connecting to a solid state storage device in a midplane with the a switching device; and
associating the server with the solid state storage device.

10. The method of claim 9, further comprising:
identifying a failed server;
de-allocating one or more solid state storage devices associated with the failed server; and
re-allocating the one or more solid state storage devices to a functional server.

11. The method of claim 9, further comprising:
identifying a failed solid state storage device; and
de-allocating the failed solid state storage devices from an associated server.

12. The method of claim 11, further comprising allocating a functional solid state storage device to the associated server.

13. The method of claim 9, wherein the solid state storage device is a PCIe flash module.

14. The method of claim 13, wherein the server comprises a virtual machine.

15. The method of claim 9, wherein the server comprises a virtual machine.

16. A processor in a switching device configured to:
connect to two or more servers;
connect to two or more solid state storage devices;
allocate a first solid state storage device in the two or more solid state storage devices to a first server in the two or more servers;
route data traffic between the first server in the two or more servers and the first solid state storage device in the two or more solid state storage devices;
allocate a second solid state storage device in the two or more solid state storage devices to a second server in the two or more servers; and
route data traffic between the second server in the two or more servers and the second solid state storage device in the two or more solid state storage devices.

17. The processor of claim 16, wherein at least one of the two or more solid state storage devices is a PCIe flash module.

18. The processor of claim 16, further configured to:
identify the first server as unavailable;
de-allocate the first solid state storage device from the first server; and
re-allocate the first solid state storage device to the second server.

19. The processor of claim 16, further configured to:
identify the first solid state storage device as unavailable; and
de-allocate the first solid state storage device from the first server.

20. The processor of claim 19, further configured to allocate a third solid state storage device in the two or more solid state storage devices to the first server.
